(19) United States
(12) Patent Application Publication
(10) Pub. No.: US 2008/0245052 A1
(43) Pub. Date: Oct. 9, 2008

(54) Integrated Biomass Energy System

(76) Inventors: Phiroz M. Boyce, Spring, TX (US); Meherwan P. Boyce, Houston, TX (US)

Correspondence Address: Baker Botts, L.L.P., 910 Louisiana, Houston, TX, 77002-4995, US

(21) Appl. No.: 11/863,731

(22) Filed: Sep. 28, 2007

Related U.S. Application Data
(60) Provisional application No. 60/848,466, filed on Sep. 29, 2006.

(51) Int. Cl. F02C 3/26

(52) U.S. Cl. 60/39.464

(57) ABSTRACT

An indirect-fired biomass-fueled gas turbine system with a combustor for combustion of biomass particles to produce a combustion gas, a heat exchanger providing a heat exchange relationship between combustion gas from the combustor and compressed air, and a gas turbine. The combustor may be a cyclonic combustor with a combustion liner forming a combustion chamber, a biomass feed inlet at one end of the combustion chamber formed through the combustion liner for receiving the biomass particles from a fuel feed system, wherein the biomass feed inlet is formed so that the biomass particles are introduced into the combustion chamber with a tangential component, and a plurality of air tuyeres formed through the combustion liner for receiving air, wherein at least one of the air tuyeres is arranged to introduce the air into the combustion chamber with a tangential component.

This application claims the benefit of U.S. Provisional Application Ser. No. 60/848,466, filed Sep. 29, 2006 (pending).

### BACKGROUND

There are a number of industries that generate large quantities of biomass. Two examples include the forest products and agricultural industries. For example, in the forest product industries, large quantities of biomass are generated, including sawdust, bark, twigs, branches and other wood residue. Likewise, in the agricultural industries, each crop cycle results in large quantities of residual biomass, including bagasse, corn cobs, rice hulls, and orchard and vine trimmings. Additional biomass residue that is generated also includes sludge and manure. Despite the large quantities that are produced, this residue biomass economically be easily utilized for commercial purposes.

Because of its limited uses, biomass oftentimes has a low value (or sometimes negative) in the market. Further, biomass is a combustible product and, therefore, it is frequently used for power generation. Additionally, because biomass is a renewable resource and because biomass releases the same amount of carbon to the atmosphere as it does when it decomposes naturally, the use of biomass for power generation may address several problems with conventional fossil fuels.

The most common technique for power generation using biomass is utilization of steam turbines. This technique requires the burning of the biomass in a boiler to produce steam. The steam is then used to drive a steam turbine which, in turn, drives an electric generator to produce electricity. The boiler technology typically has lower overall efficiencies and higher capital and operating costs than the direct fired combustion turbine systems discussed below. Another technique that has been developed for using biomass for power generation is gasification. In gasification, the biomass is converted to a combustible gas, which may then be used as fuel to generate electricity, for example via a gas turbine. Gasification techniques typically have lower thermal efficiencies and higher capital and operating costs than the direct-fired gas turbine power systems discussed below.

As an alternative to gasification and steam generation techniques, power systems that generate electricity by driving gas turbines, using solid fuels such as biomass, have also been used. Gas turbine power systems that operate on solid fuel may be designed as either indirect-fired or direct-fired systems. These systems typically have several primary components, including an air compressor, a furnace or combustor, a turbine and an electric generator. The electric generator and air compressor are driven by energy created by expansion of hot compressed air through the turbine. This hot compressed air for expansion across the turbine is generated by compressing air in the compressor and heating the resultant compressed air with thermal energy generated by the furnace or combustor.

In indirect-fired systems, the furnace or combustor typically operates as a separate functional unit apart from a functional unit containing the air compressor and the turbine. This indirect-firing design protects the gas turbine from corrosive effluents and particulate matter, which are typically present in the hot exhaust gases from a furnace or combustor burning biomass, by using a high temperature heat exchanger. In the high temperature heat exchanger, ducts containing the compressed air from the compressor may be placed in close proximity to ducts bearing highly heated exhaust gases from the furnace or combustor, resulting in exchange of heat from the hot exhaust gases to the compressed air. This heated and compressed air then drives the turbine, which in turn drives the air compressor and electric generator. In addition to higher capital costs and operating costs, these indirect-fired systems have lower thermal efficiencies than direct-fired systems.

In direct-fired systems, the solid fuel is burned in a pressurized combustor, and the heated effluent gases from the combustor are vented directly into the turbine. The combustor is part of an integrated, pressurized unit that includes the compressor and the turbine. In many instances, gas cleaning equipment may be employed between the combustor and turbine to reduce the entry of corrosive effluents and particulate matter into the turbine.

### SUMMARY

In one embodiment of the present invention, an indirect-fired biomass-fueled gas turbine system comprises a combustor for combustion of biomass particles to produce a combustion gas, a heat exchanger providing a heat exchange relationship between combustion gas from the combustor and compressed air, and a gas turbine comprising a turbine section comprising an inlet in communication with the heat exchanger for receiving the heated compressed air from the heat exchanger, wherein the turbine section is driven by the heated compressed air.

In another embodiment of the present invention, an indirect-fired biomass-fueled gas turbine system may comprise a fuel feed system and a cyclonic combustor for combustion of biomass particles to produce a combustion gas and ash particulate, the cyclonic combustor comprising: a combustion liner forming a combustion chamber having a generally cylindrical shape and having an ignition zone, a combustion zone, and a dilution zone arranged longitudinally along the axis of the combustion chamber, with a tangential component, and a plurality of air tuyeres formed through the combustion liner for receiving air, wherein the plurality of air tuyeres are arranged to introduce the air into the combustion chamber with a tangential component, wherein the plurality of air tuyeres are spaced along the length of the combustion liner about the biomass feed inlet, wherein the plurality of air tuyeres supplies a sufficient amount of air to the ignition zone for ignition of the biomass particles to begin the combustion, wherein the plurality of air tuyeres supplies a sufficient amount of air to the combustion zone to complete the combustion of the biomass particles from the ignition zone, and wherein the plurality of air tuyeres supplies a sufficient amount of air to the dilution zone to dilute the combustion gas to a temperature suitable for use in a gas turbine. The indirect-fired biomass-fueled gas turbine system may further comprise a heat exchanger providing a heat exchange relationship between combustion gas from the combustion chamber and compressed air. Additionally, the indirect-fired biomass-fueled gas turbine system may comprise the gas turbine, comprising a turbine section comprising an inlet in communication with the heat exchanger for receiving the heated compressed air from the heat exchanger, wherein the turbine section is driven by the heated compressed air.

In yet another embodiment of the present invention, an indirect-fired biomass-fueled gas turbine system may comprise a fuel feed system and a cyclonic combustor for combustion of biomass particles to produce a combustion gas and particulate ash, the cyclonic combustor comprising: a combustion liner forming a combustion chamber having a generally cylindrical shape, a biomass feed inlet at one end of the combustion chamber formed through the combustion liner for receiving biomass particles from the fuel feed system, wherein the biomass feed inlet is formed so that the biomass particles are introduced into the combustion chamber with a tangential component, a plurality of air tuyeres formed through the combustion liner for receiving air, wherein the plurality of air tuyeres are arranged to introduce the air into the combustion chamber with a tangential component, wherein the plurality of air tuyeres are spaced along the length of the combustion liner from the biomass feed inlet, and a cyclonic ash separator comprising: a choke element comprising an opening of reduced cross-sectional area as compared to the cross-sectional area of the combustion chamber, wherein the choke element has an input in communication with the combustion chamber outlet for receiving the combustion gas from the combustion chamber, and a particulate ash opening defined between the choke element and the combustion liner, wherein at least a portion of the particulate ash exits the combustion chamber via the particulate ash opening. The indirect-fired biomass-fueled gas turbine system may further comprise a heat exchanger providing a heat exchange relationship between combustion gas from the combustion chamber and compressed air, and a gas turbine comprising a turbine section comprising an inlet in communication with the heat exchanger for receiving the heated compressed air from the heat exchanger, wherein the turbine section is driven by the heated compressed air.

In still another embodiment of the present invention, a method for indirect firing a gas turbine may comprise supplying biomass particles to a combustor, supplying air to the combustor, burning the biomass particles in the combustor to produce a combustion, supplying the combustion gas from the combustor to a heat exchanger, supplying compressed air to the heat exchanger, allowing heat transfer from the combustion gas to the compressed air within the heat exchanger; supplying heated compressed air from the heat exchanger to a gas turbine comprising a turbine section, and allowing the heated compressed air to expand through the turbine section of the gas turbine so as to generate mechanical energy.

### BRIEF DESCRIPTION OF THE DRAWINGS

FIG. 1 is a schematic illustration of an example indirect-fired biomass-fueled gas turbine system in accordance with one embodiment of the present invention.

FIG. 2 is a schematic illustration of an example combustor in accordance with one embodiment of the present invention.

FIG. 3 is a cross-sectional view of the feed inlet taken along lines 3-3 of FIG. 2.

FIG. 4 is a cross-sectional view of the air inlet taken along lines 4-4 of FIG. 2.

FIG. 5 is a cross-sectional view of the air inlet taken along lines 5-5 of FIG. 2.

FIG. 6 is a schematic illustration of an example combustor in accordance with another embodiment of the present invention.

FIG. 7 is a schematic illustration of an example combustor in accordance with another embodiment of the present invention.

FIG. 8 is a schematic illustration of an example combustor containing a cyclonic ash separator in accordance with one embodiment of the present invention.

FIG. 9 shows a front view of a heat exchanger in accordance with one embodiment of the present invention.

FIG. 10 shows a top view of the heat exchanger of FIG. 9.

FIG. 11 shows an end view of the heat exchanger of FIG. 9.

FIG. 12 shows a perspective view of the heat exchanger of FIG. 9.

### DETAILED DESCRIPTION

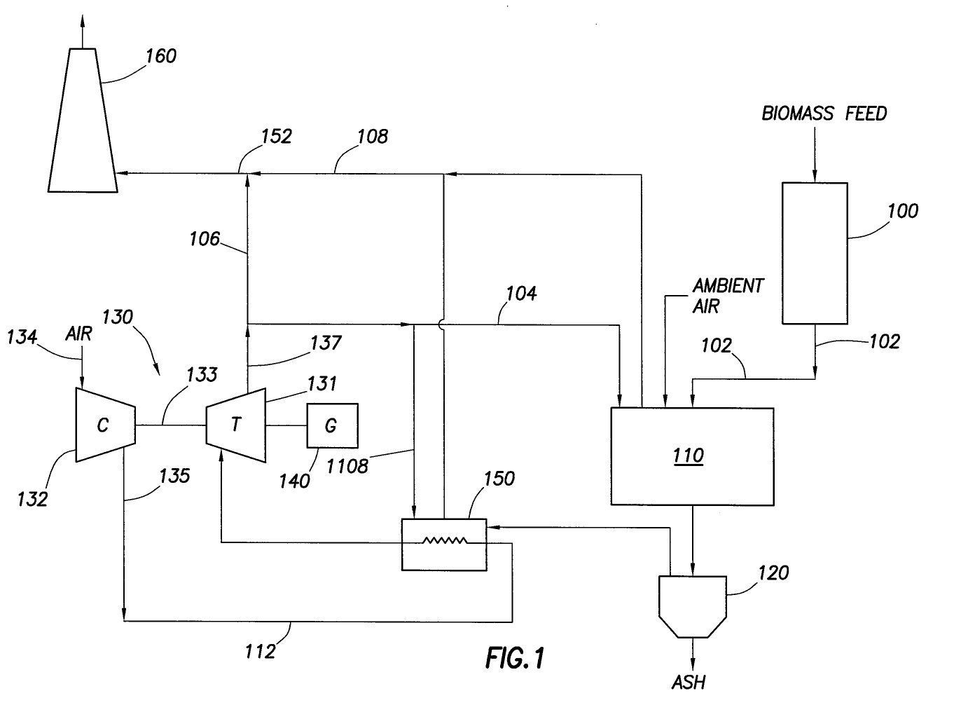

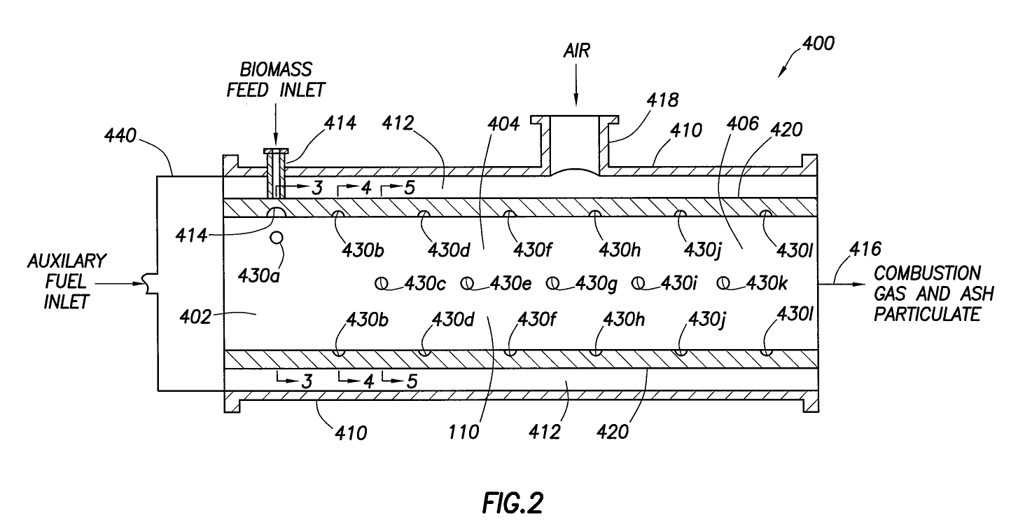

FIG. 1 schematically illustrates a new indirect-fired biomass-fueled gas turbine system. This biomass-fueled gas turbine system may be particularly suitable for small-scale power systems, for example, for the generation of less than about 10 megawatts and, in some examples, in the range of about 0.5 to about 10 megawatts. The system depicted in FIG. 1 generally comprises fuel feed system 100, combustion chamber 110, cyclonic ash separator 120, heat exchanger 150, gas turbine 130, and generator 140. Biomass particles are supplied to fuel feed system 100 at substantially atmospheric pressure. Fuel feed system 100 supplies biomass particles to combustion chamber 110 at substantially the operating pressure of combustion chamber 110 through fuel feed line 102. Example embodiments of combustion chamber 110 are described in more detail with respect to FIGS. 2 and 6-8.

The biomass particles supplied to fuel feed system 100 may comprise any suitable source of biomass, including sawdust, bark, twigs, branches, other waste wood, bagasse, corn cobs, rice hulls, orchard and vine trimmings, sludge, manure, and combinations thereof. The biomass particles supplied to fuel feed system 100 may have a particle size suitable for cyclonic combustion. For example, the biomass particles may be sized so that they have a major dimension of less than about 3 millimeters (“mm”). Further, the biomass particles also may have a moisture content suitable for cyclonic combustion, for example, the biomass particles may be dried so that they have a moisture content of less than about 30% and, preferably, a moisture content in the range of about 8% to about 16%. Those of ordinary skill in the art may recognize that cyclonic combustion generally may have different feed requirements (e.g., size and moisture content) than other types of combustion.

The biomass particles are burned in combustion chamber 110. Cyclonic combustion of the biomass particles produces ash particulate and a hot, pressurized combustion gas, for example, at a temperature in the range of about 1,800° F. to about 2,800° F. and, in some embodiments, in the range of about 2,200° F. to about 2,400° F.

Air is also supplied to combustion chamber 110 through exhaust air feed line 104. The exhaust air may be supplied into combustion chamber 110 so as to promote cyclonic motion within combustion chamber 110. For example, as illustrated by FIGS. 4 and 5, the exhaust air may be supplied to combustion chamber 110 tangentially. In addition to providing sufficient oxygen for combustion, a sufficient amount of the exhaust air may also be supplied to combustion chamber 110 to dilute the combustion gas so that it has a temperature suitable for use in heat exchanger 150, for example, a temperature less than about 2,200° F. and, in one example, in the range of about 1,500° F. to about 2,200° F. Combustion chamber 110 may have an outlet to direct combustion gas to stack 160.

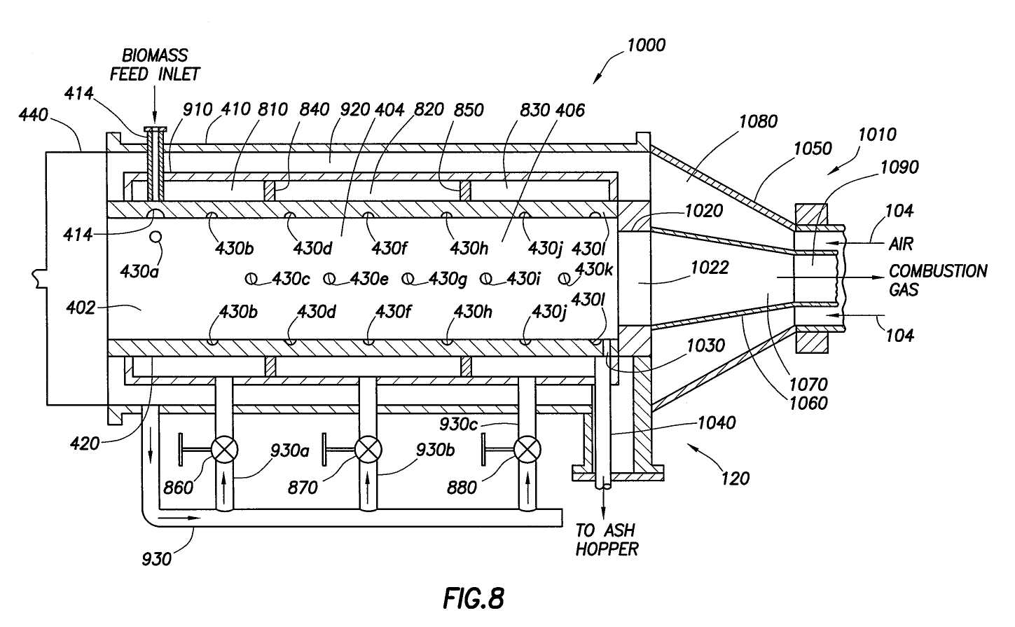

The combustion gas and ash particulate produced from burning the biomass particles are then supplied to cyclonic ash separator 120. Cyclonic ash separator 120 utilizes centrifugal forces to separate ash particulate from the combustion gas. Preferably, at least about 50% of the ash particulate may be separated from the combustion gas. Those of ordinary skill in the art will recognize that cyclonic ash separator 120 may separate at least a portion (and preferably at least a substantial portion) of the larger ash particulate (e.g., greater than about 10 microns) from the combustion gas but may not separate a substantial portion of the smaller ash particulate (e.g., less than about 1 micron). For example, at least about 80% (preferably, at least about 90%) of ash particulate greater than about 10 microns may be separated from the combustion gas. An example cyclonic ash separator 120 integrated with combustion chamber 110 is described in more detail with respect to FIG. 8.

The combustion gas from cyclonic ash separator 120 is then supplied to heat exchanger 150, which provides a heat exchange between the combustion gas and compressed gas entering gas turbine 130. Gas turbine 130 comprises turbine section 131 and compressor section 132. Expansion of the heated compressed gas through turbine section 131 provides mechanical energy to drive compressor section 132. Expansion of the heated compressed gas through turbine section 131 also provides the mechanical energy necessary to drive generator 140 for generating electric power. As depicted in FIG. 1, gas turbine 130 may have a single shaft 133 so that both turbine section 131 and compressor section 132 may be driven by a single turbine. Alternatively, while not depicted in turbine section 131 may be comprise two shafts operating at different rotational shaft speeds, for example, a first shaft (not depicted) may be used to drive compressor section 132 and a second shaft (not depicted) may be used to drive generator 140.

Gas turbine 130 may be any suitable gas turbine. For example, gas turbine 130 may be a gas-fired turbine wherein the burner has been replaced by combustion chamber 110. Also, gas turbine 130 may have any of a variety of pressure ratios. For example, gas turbines suitable for use may have pressure ratios in the range of about 8:1 to about 20:1. Furthermore, gas turbine 130 may be capable of dual firing, wherein the gas turbine may be fired using an auxiliary fuel, for example, gas, propane or a liquid fuel. The auxiliary fuel may be used, for example, when fuel feed system 100 and/or fuel input systems are not operating such as when one or more of those systems are down for maintenance

Compressor section 132 intakes air via air inlet 134. Turbine section 131 drives compressor section 132 to compress the air and produce compressed air stream 135. An auxiliary motor (not depicted) may be used to drive compressor section 132 during startup of the system. A portion of compressed air stream 135 may be supplied to heat exchanger 150 through compressed air feed line 112.

Exhaust stream 137, obtained by expanding the combustion gas through turbine section 131, may be at or near atmospheric pressure and at a temperature in the range of about 600° F. to about 1,200° F. and, in some examples, in the range of about 900° F. to about 1,000° F. As desired for a particular application, exhaust stream 137 may be used directly or indirectly to provide thermal energy for a particular application. For example, exhaust stream 137 may be used to generate steam, heat another fluid that may be used for heating purposes, preheat the biomass particles, and/or dry the biomass particles. As depicted in FIG. 1, a portion 106 of exhaust stream 137 may be passed through a heat recovery unit (not shown) (e.g., a heat exchanger or dryers) so as to provide thermal energy for a desired application. Another portion 104 of exhaust stream 137 may be used as the air feed for combustion chamber 110. After passing through combustion chamber 110 and heat exchanger 150, it may exit as stream 108. From the heat recovery unit and/or the heat exchanger 150, exhaust stream 152 exits the system through stack 160.

FIG. 2 schematically illustrates an example cyclonic combustor 400 for the combustion of biomass particles in combustion chamber 110. As depicted in FIG. 2, cyclonic combustor 400 generally comprises a metal outer casing 410, a combustion liner 420 forming a substantially cylindrically shaped combustion chamber 110. Cyclonic combustor 400 further comprises a biomass feed inlet 414 formed through combustion liner 420 for receiving biomass particles from fuel feed system 100 through fuel feed line 102. For exit of the combustion gas and the ash particulate produced within combustion chamber 110 from combustion of the biomass particles, cyclonic combustor further comprises combustion chamber outlet 416. Further, a plurality of air tuyeres 430a, 430b, 430c, etc. are arranged to introduce air into combustion chamber 110.

Outer casing 410 may have a generally cylindrical shape. Metal outer casing surrounds combustion liner 420 so as to define air feed plenum 412 between outer casing 410 and combustion liner 420. Combustion liner 420 may have a generally cylindrical shape and defines combustion chamber 110. Combustion liner 420 may comprise a material that is suitable for the operating conditions of combustion chamber 110. In some embodiments, the materials may be suitable for temperatures up to about 3,000° F. Examples of suitable materials include refractory materials and metals.

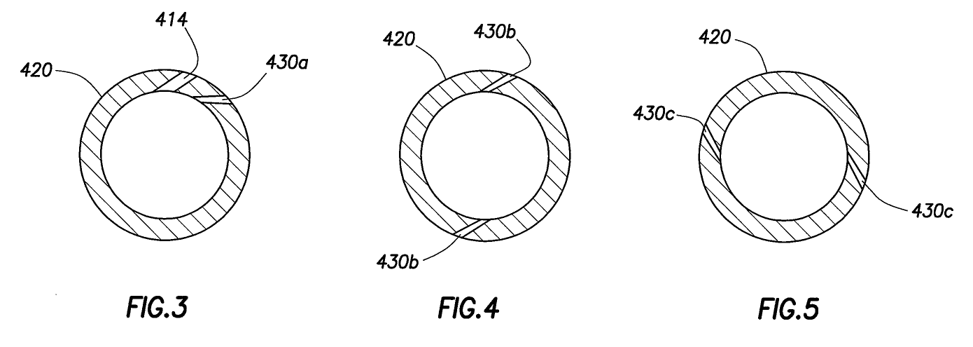

Combustion chamber 110 receives biomass particles for combustion through biomass feed inlet 414 at one end of combustion chamber 110. Biomass feed inlet 414 is formed through outer casing 410 and combustion liner 420. As illustrated by FIG. 3, biomass feed inlet 414 may be formed with a tangential component with respect to the longitudinal axis of combustion liner 420, or with respect to any circle formed about the longitudinal axis. This arrangement promotes the cyclonic motion of the biomass particles in combustion chamber 110. Air tuyere 430a provides air that disperses the biomass particles supplied to combustion chamber 110. In combustion chamber 110, the biomass particles are entrained at a tangential velocity greater than about 80 feet per second (“ft/sec”) and, in some examples, in the range of about 100 ft/sec to about 200 ft/sec.

Combustion chamber 110 generally comprises three different zones, namely, ignition zone 402, combustion zone 404, and dilution zone 406. These three zones are arranged longitudinally along the axis of combustion chamber 110 with ignition zone 402 at one end of combustion chamber 110 and the dilution zone 406 at the other end of combustion chamber 110. Combustion zone 404 is located between ignition zone 402 and dilution zone 406.

In combustion chamber 110, the biomass particles are burned to produce particulate ash and a hot, combustion gas. The biomass particles enter combustion chamber 10 in ignition zone 402. In ignition zone 402, the biomass particles may be ignited. A sufficient amount of air may be supplied to ignition zone 402 through air tuyeres 430a, 430b, 430c to ignite the biomass particles and facilitate at least partial combustion of the biomass particles. A substoichiometric amount of air may be supplied to ignition zone 402 through air tuyeres 430a, 430b, 430c so that the biomass particles and oxygen in the air react in a substoichiometric combustion. Substoichiometric combustion may be desired, in some examples, to control the flame temperature of the biomass particles so as to reduce the formation of nitrous oxides from the combustion of the biomass particles.

Biomass particles and combustion products pass from ignition zone 402 to combustion zone 404 wherein the combustion of the biomass particles is completed. In addition to a sufficient supply of air for combustion, the air supplied to combustion zone 404 by air tuyeres 430d, 430e, 430f, 430g, 430h also dilutes the combustion products.

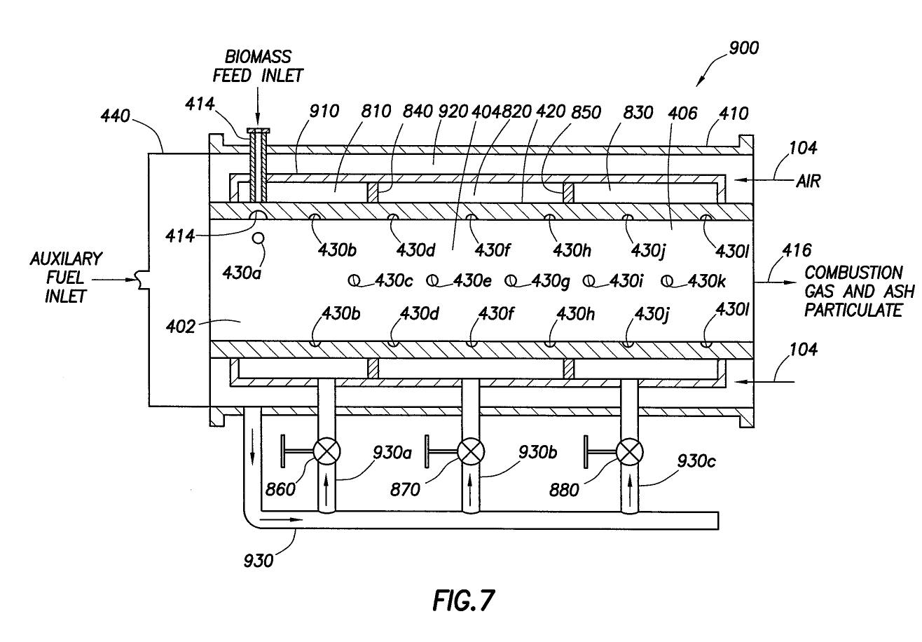

After passing through combustion zone 404, the combustion products enter dilution zone 406. A sufficient amount of air may be supplied to dilution zone 406 by air tuyeres 430i, 430j, 430k, 430l to complete dilution of the combustion products. Complete dilution of the combustion gas may facilitate cooling of the combustion gas to a temperature suitable for entry into heat exchanger 150, and passage of the product of the heat exchange through gas turbine 130, for example, less than about 2,200° F. and, in some examples, in the range of about 1,500° F. to about 2,2000 F. Completing dilution in combustion chamber 110 may be desired, for example, where combustor 400 further comprises cyclonic ash separator 120, as illustrated in FIG. 8. The combustion gas and particulate ash produced from combustion of the biomass particles exit dilution zone 406 via combustion chamber outlet 416 (see FIG. 7). Combustion chamber outlet 416 may be at the opposed end of combustion chamber 110 from biomass feed inlet 414.

As discussed above, the air needed for combustion of the biomass particles and dilution of the combustion products is supplied to combustion chamber 110 through a plurality of air tuyeres 430a, 430b, 430c, etc. formed through combustion liner 420. The tuyere openings generally may have a conical shape (narrowing towards the combustion chamber), and a length/width aspect ratio exceeding about 2:1 and, in some examples, in a range of 3:1 to 5:1. As illustrated by FIGS. 4 and 5, air tuyeres 430a, 430b, 430c, etc. may be formed with a tangential component with respect to the longitudinal axis of combustion liner 420, or with respect to any circle formed about the longitudinal axis. This arrangement promotes cyclonic motion within combustion chamber 110. The air needed for combustion may be supplied through the plurality of air tuyeres 430a, 430b, 430c, etc. at a tangential velocity greater than about 100 ft/sec and, in some examples, in the range of about 110 ft/sec to about 150 ft/sec. The air tuyeres 430a, 430b, 430c, etc. are in communication with air feed plenum 412 (see FIG. 2), which may be supplied air via exhaust air feed line 104. Exhaust air feed line 104 supplies the air to air feed plenum 412 through air inlet 418 formed through outer casing 410.

The tuyeres 430a, 430b, 430c, etc. may be constructed and arranged to supply the air needed in each zone of combustion chamber 110. Rows containing at least one of the plurality of air tuyeres 430a, 430b, 430c, etc. are generally spaced apart along the length of combustion liner 420 and number in the range of about 2 rows to about 20 or more rows. In one example, there are 12 rows spaced along the length of combustion liner 420. In one example, there are four rows in ignition zone 402, 5 rows in combustion zone 404, and 3 rows in dilution zone 406. Each row may contain from one to about 20 or more tuyeres distributed in the same plane. As indicated in FIGS. 2-8, air tuyeres 430a, 430b, 430c, etc. may be arranged in a staggered pattern, wherein at least one tuyere in each row is displaced 90° along the circumference of combustion liner 420 with respect to the preceding row. For example, air tuyeres 430b may be displaced 90° along the longitudinal axis of combustion liner 420 with respect to air tuyeres 430c.

Also, each of the plurality of tuyeres 430a, 430b, 430c, etc. may have the same size or different sizes as desired for a particular application. For example, the tuyeres 430a, 430b, 430c, etc. in the same row and/or zone may be the same or different sizes as desired for a particular application. Tuyere size may be adjusted to control the air flow into the zones of combustion chamber 110 and thus control the flame temperature of the biomass particles. As desired, the flame temperature may be adjusted to reduce the formation of nitrogen oxides from the combustion. In some embodiments, at least one tuyere in each row may increase in size along the length of combustion liner 420 from biomass feed inlet 414. In one example, the tuyeres 430a, 430b, 430c, etc. may linearly increase in size. While not illustrated in FIG. 2, tuyeres 430b would be larger than tuyere 430a, tuyeres 430c would be larger than tuyeres 430b with tuyeres 430i, 430j, 430k, 430l being the largest tuyeres in combustion liner 420. In some embodiments, the tuyeres 430a, 430b, 430c of the ignition zone 402 and the tuyeres 430d, 430e, 430f, 430g, 430h of combustion zone 404 may increase in size along the longitudinal axis of combustion chamber 110 from biomass feed inlet 414. For example, the tuyeres 430d, 430e, 430f, 430g, 430h of combustion zone 404 may be larger than the largest tuyere in ignition zone 402. The holes in dilution zone 406 may be the same or larger than the largest tuyeres in ignition zone 402 and combustion zone 404.

Those of ordinary skill in the art will recognize that computational fluid modeling may be used to determine the optimal tuyere size, tangential velocity of the air, the number of tuyeres in each zone of combustion chamber 110, and the quantity of air supplied to each zone.

Combustor 400 further may comprise burner 440. Burner 440 may operate on an auxiliary fuel, such as natural gas, propane, or a liquid fuel. Burner 440 may be used during startup of combustor 400 to heat combustion liner 420 to a temperature sufficient to ignite the biomass particles and/or ignite the biomass particles for a desired period of time during startup. Burner 440 may be sized for startup only, or, alternatively, burner 440 may be sized to allow full throughput through the system so that electrical output from generator 140 may remain constant, for example, where the supply of biomass particles may be restricted. In one example, burner 440 is capable of firing a gas turbine, such as gas turbine 130.

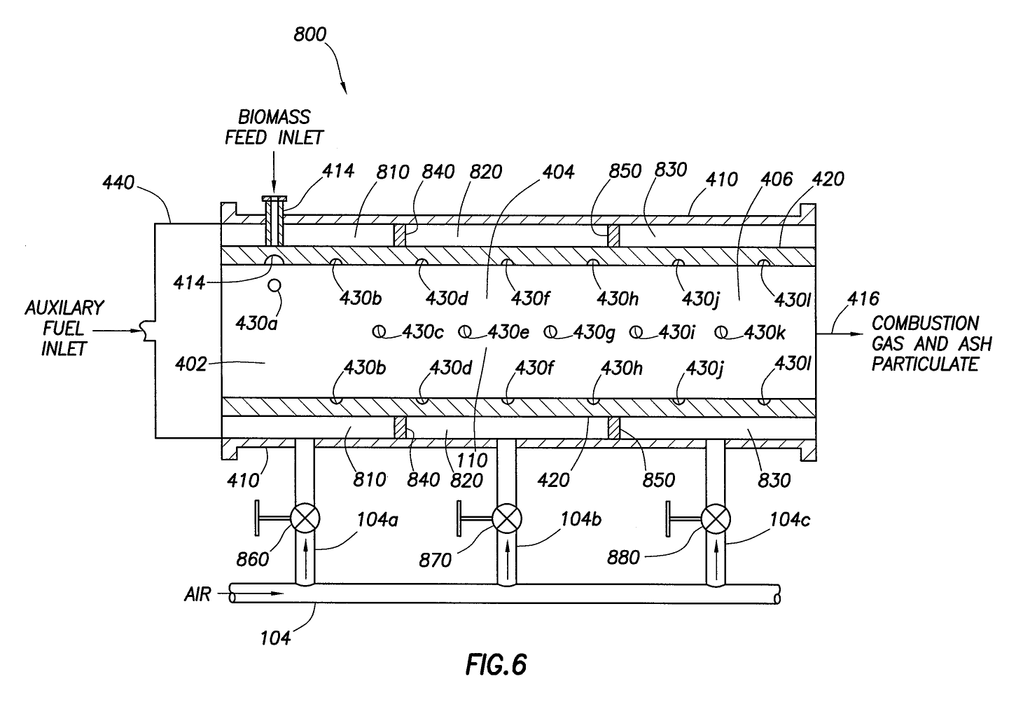

FIG. 6 schematically illustrates an alternate cyclonic combustor 800. Cyclonic combustor 800 is similar to cyclonic combustor 400 depicted on FIG. 2, except that cyclonic combustor 800 comprises a plurality of air feed plenums 810, 820, 830 defined between outer casing 410 and combustion liner 420. The plurality of air feed plenums 810, 820, 830 are separated by a plurality of baffles 840, 850. Each of the plurality of air feed plenums 810, 820, 830 is in communication with at least one of the plurality of air tuyeres 430. For example, first plenum 810 is in communication with air tuyeres 430a, 430b, 430c. Air tuyeres 430a, 430b, 430c, etc. are supplied air from exhaust air feed line 104 via air feed plenums 810, 820, 830. Each of the plurality of air feed plenums 810, 820, 830 communicate with a respective portion 104a, 104b, 104c of exhaust air feed line 104. According to the operational requirements of each zone of combustion chamber 110, air supply into each of the plurality of air feed plenums 810, 820, 830 is controlled by a plurality of valves 860, 870, 880, respectively. For example, valve 860 may control the supply of air into ignition zone 402 of combustion chamber 110 to ensure a sufficient supply of air to ignite the biomass particles. Valve 870 may control the supply of air into combustion zone 404 of combustion chamber 110 to ensure a sufficient supply of air to completely combust the biomass particles and begin dilution of the combustion products. Valve 880 may control the supply of air into dilution zone 406 of combustion chamber 110 to ensure a sufficient supply of air to completely dilute the combustion products.

FIG. 7 schematically illustrates an alternate cyclonic combustor 900. Cyclonic combustor 900 is similar to cyclonic combustor 800 depicted on FIG. 6, except that cyclonic combustor 900 further comprises an intermediate lining 910 having a generally cylindrical shape between outer casing 410 and combustion liner 420. Cooling plenum 920 is defined between outer casing 410 and combustion liner 420. Air enters cooling plenum 920 through exhaust air feed 104 and is pre-heated by radiant heat from combustion chamber 110 thereby cooling combustion chamber 110. After being pre-heated, this air enters tube 930 which separates into three portions 930a, 930b, and 930c. Each of the plurality of air feed plenums 810, 820, 830 communicate with respective valve 860, 870, 880 so that air is supplied to a respective zone of combustion chamber 110 through air tuyeres 430. According to the operational requirements of each zone of combustion chamber 110, air supply into each of the plurality of air feed plenums 810, 820, 830 is controlled by a plurality of valves 860, 870, 880, respectively.

FIG. 8 schematically illustrates an alternate cyclonic combustor 1000. Cyclonic combustor 1000 is similar to cyclonic combustor 900 depicted on FIG. 7, except that cyclonic combustor 1000 further comprises cyclonic ash separator 120 and transition assembly 1010. In general, cyclonic ash separator 120 comprises choke element 1020, particulate ash opening 1030 formed between choke element 1020 and combustion liner 420, and ash collection passageway 1040 in communication with combustion chamber 110 via particulate ash opening 1030.

At the exit of dilution zone 406 of combustion chamber 110, a centrally located choke element 1020 is provided with opening 1022 therein. Opening 1022 in choke element 1020 may be generally cylindrical in shape or have any other suitable shape. For example, opening 1022 may be made with a generally non-circular shape. Opening 1022 may have a cross-sectional area smaller than that of combustion chamber 110. For example, opening 1022 may have a cross-sectional area in the range of about 80% to about 90% of the cross-sectional area of combustion chamber 110. If desired choke element 1020 may be lined with a material (e.g., a refractory material or a metal) that is suitable for the operating conditions of combustion chamber 110.

Particulate ash opening 1030 is located between choke element 1020 and combustion liner 420. Particulate ash opening 1030 may extend from 90° to about 180° along the circumference of the lower half of combustion liner 420. Ash collection passageway 1040 is in communication with combustion chamber 110 via particulate ash opening 1030.

Transition assembly 1010 generally may be constructed and arranged to minimize the transfer of forces from cyclonic combustor 1000. In general, transition assembly 1010 comprises outer casing 1050 and inner shell 1060 forming a substantially cylindrically shaped combustion gas passageway 1070.

Outer casing 1050 may have a generally conical shape with the wider end adjacent to combustion chamber 110. Alternatively, outer casing 1050 may have a cylindrical shape or may be non-circular shaped. Outer casing 1050 surrounds inner shell 1060 so as to define cooling plenum 1080 between outer casing 1050 and inner shell. Transition assembly 1010 may be constructed and arranged so that cooling plenum 1080 of transition assembly 1010 is in communication with cooling plenum 920 of cyclonic combustor 1000. While not depicted in FIG. 8, outer casing 1050 of transition assembly 1010 may be coupled to outer casing 410 of cyclonic combustor 1000 using any suitable method, for example, a bolted flange may be used to couple outer casing 1050 to outer casing 410.

A substantially cylindrically shaped combustion gas passageway 1070 comprising an inlet and an outlet is defined by inner shell 1060. Alternatively, combustion gas passageway 1070 may be any other suitable shape, for example, non-circular. Combustion gas passageway 1070 may be tapered from cyclonic ash separator 120 to transition assembly outlet 1090 so that the outlet of the combustion gas passageway 1070 has a smaller cross-sectional area than the inlet. Transition assembly 1010 may be constructed and arranged so that combustion gas passageway 1070 is in communication with combustion chamber 110 via opening 1022 in choke element 1020 of cyclonic ash separator 120.

In operation, due to the cyclonic motion and high tangential velocity of the combustion gas and particulate ash in combustion chamber 110, high centrifugal forces are generated thereon. As a result of the centrifugal forces, the particulate ash revolves in combustion chamber 110 adjacent to combustion liner 420 so that the particulate ash passes through particulate ash opening 1030 and passes through ash collection passageway 1040 to ash hopper (not depicted) where it is collected. The combustion gas generally moves from combustion chamber 110 to opening 1022 in choke element 1020 to combustion gas passageway 1070. While passing through combustion gas passageway 1070, the combustion gas is cooled by heat exchange with the air in cooling plenum 1080 from exhaust air feed 104 and ambient air. The air passes through cooling plenum 1080 to cooling plenum 920 of combustor 1000. The combustion gas generally exits transition assembly 1010 via transition assembly outlet 1090 after passing through combustion gas passageway 1070. This combustion gas is then supplied to the heat exchanger 110 as depicted in FIG. 1.

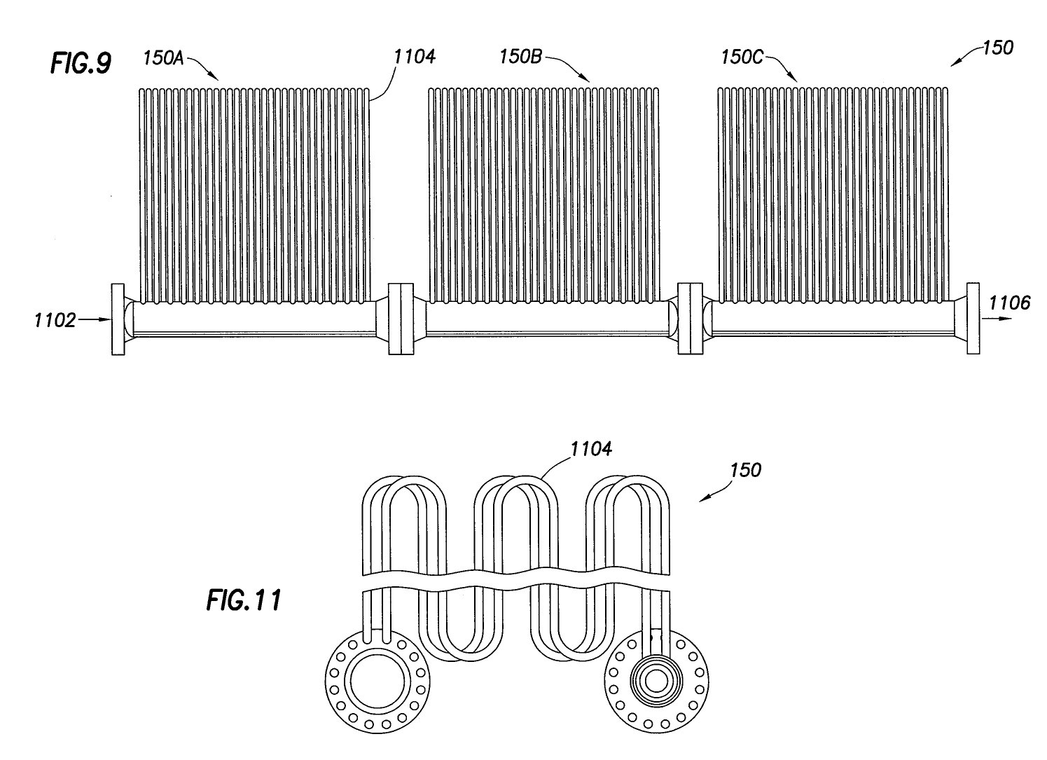

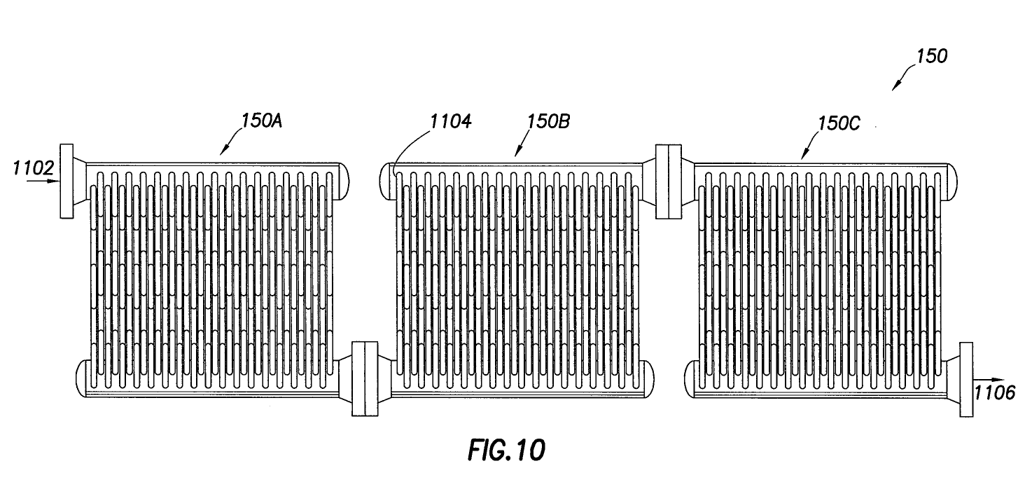

Referring now to FIGS. 9 and 10, shown therein are a front view and a top view, respectively, of heat exchanger 150 in accordance with one embodiment of the present invention. Heat exchanger 150 may be a gas-to-gas heat exchanger, commonly referred to as an air heat exchanger. Heat exchanger 150 may include a first inlet 1102 for receiving pressurized air from air compressor 132, heat exchanging surface 1104 for conveying heat from the exhaust stream 137 to the pressurized air, and a first outlet 1106 to direct the pressurized, hot air out of the heat exchanger 150 for passage to the gas turbine 131. Additionally, heat exchanger 150 may include a second inlet 1108 for receiving part of exhaust stream 137 and a second outlet 1110 to direct stream 108 out of the heat exchanger 150. Heat exchanging surface 1104 may be a high temperature alloy material.

The heat exchanger 150 may have a plurality of helically disposed tubes that generally define a cylinder through which the pressurized air is directed. However, the heat exchanger 150 may be of any other conventional design that maximizes transfer of heat from the exhaust stream 137 to the pressurized air passing through the air heat exchanger 150. Heat exchanger 150 is adapted to receive pressurized (and therefore heated) air from compressor section 132 via compressed air feed line 112. Air passing through compressed air feed line 112 into heat exchanger 150 is heated as a result of the pressurization. However, after heat exchange with the exhaust stream 137, the air that is discharged from heat exchanger 150 through the first outlet 1106 is much hotter. For example, the temperature of the air may be approximately 650° F. at first inlet 1102 and approximately 1700° F. at first outlet 1106.

The heat exchanger 150 may be of conventional design, utilizing a plurality of U-shaped tubes to provide the desired number of passes. It may be understood, however, that it may be desirable in some applications to use alternate conventional design, such as helically shaped tubes. The heat exchanger 150 receives pressurized air from compressor section 132. After passing through heat exchanger 150, the pressurized, hot air is directed to gas turbine section 131. Upon entering the gas turbine section 131 the air impinges upon turbine blades, thereby driving the gas turbine and generator 140 mounted thereto, generating power and providing an energy output from the power plant.

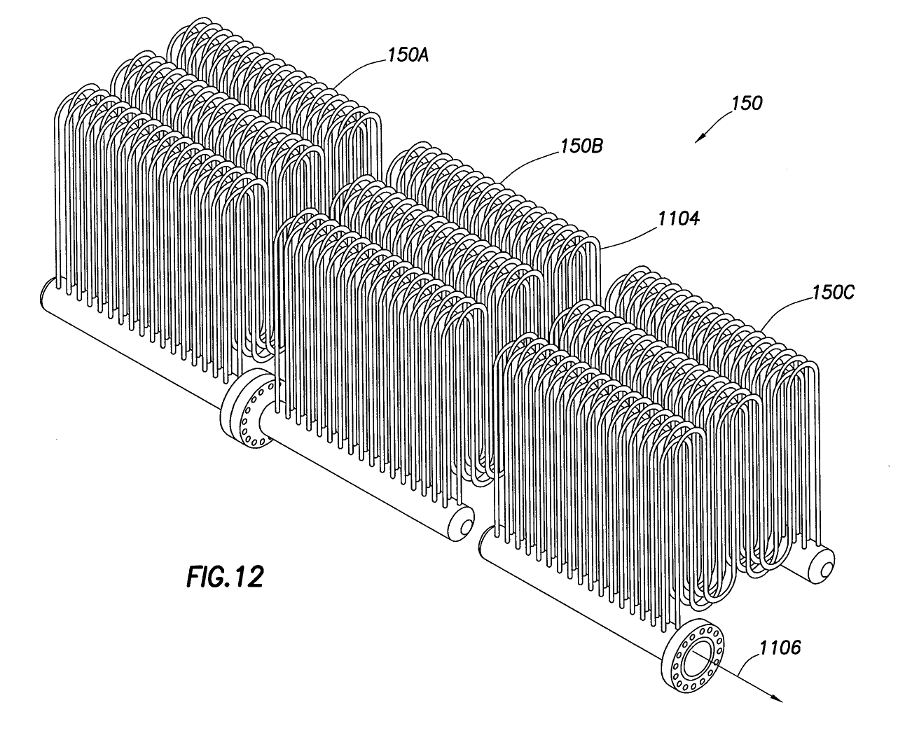

Referring now to FIGS. 9-12, a preferred embodiment of the heat exchanger 150 may be approximately 12′×14′×36′ and utilize 253MA schedule 40 material for a first section 150A and a second section 150B of the heat exchanger 150. A third section 150C may utilize 304L stainless steel schedule 40 material. The heat exchanger 150 may have external walls (not shown) insulated with light weight bat type insulation. The exhaust stream 137 may enter the heat exchanger 150 through second inlet 1108 at approximately 1000° F. and be heated to approximately 2000+ F. by firing wood particles.

The term “couple” or “couples” used herein is intended to mean either an indirect or direct connection. Thus, if a first device couples to a second device, that connection may be through a direct connection, or through an indirect electrical connection via other devices and connections.

The present invention is therefore well-adapted to carry out the objects and attain the ends mentioned, as well as those that are inherent therein. While the invention has been depicted, described and is defined by references to examples of the invention, such a reference does not imply a limitation on the invention, and no such limitation is to be inferred. The invention is capable of considerable modification, alteration and equivalents in form and function, as will occur to those ordinarily skilled in the art having the benefit of this disclosure. The depicted and described examples are not exhaustive of the invention. Consequently, the invention is intended to be limited only by the spirit and scope of the appended claims, giving full cognizance to equivalents in all respects.

1. An indirect-fired biomass-fueled gas turbine system comprising:
a combustor for combustion of biomass particles to produce a combustion gas;
a heat exchanger providing a heat exchange relationship between combustion gas from the combustor and compressed air; and
a gas turbine comprising:
a turbine section comprising an inlet in communication with the heat exchanger for receiving the heated compressed air from the heat exchanger, wherein the turbine section is driven by the heated compressed air.

2. The system of claim 1 wherein the combustor is a cyclonic combustor.

3. The system of claim 1 wherein the gas turbine further comprises a compressor section driven by the turbine section of the gas turbine, wherein the compressor section is arranged to provide the compressed air to the heat exchanger.

4. The system of claim 1 further comprising an electric generator coupled to the gas turbine for generating electric power, wherein the electric generator is driven by the turbine section of the gas turbine.

5. The system of claim 4 wherein the gas turbine further comprises:
a compressor section driven by the turbine section of the gas turbine, wherein the compressor section is arranged to provide the compressed air to the heat exchanger; and
a single shaft that drives the compressor section and the electric generator.

6. The system of claim 1 wherein the heat exchanger has an inlet for receiving exhaust from the gas turbine.

7. The system of claim 1 wherein the combustor has an inlet for receiving exhaust from the gas turbine.

8. The system of claim 1 further comprising a heat recovery unit in communication with the exhaust stream of the gas turbine.

9. The system of claim 1 further comprising a fuel feed system.

10. An indirect-fired biomass-fueled gas turbine system comprising:
a fuel feed system;
a cyclonic combustor for combustion of biomass particles to produce a combustion gas and ash particulate;
a heat exchanger providing a heat exchange relationship between combustion gas from the combustor and compressed air; and
a gas turbine, comprising a turbine section comprising an inlet in communication with the heat exchanger for receiving the heated compressed air from the heat exchanger, wherein the turbine section is driven by the heated compressed air.

11. The system of claim 10 further comprising a cyclonic ash separator.

12. (canceled)

13. (canceled)

14. A method for indirect firing a gas turbine, comprising:
supplying biomass particles to a combustor;
supplying air to the combustor;
burning the biomass particles in the combustor to produce a combustion gas;
supplying the combustion gas from the combustor to a heat exchanger;
supplying compressed air to the heat exchanger;
allowing heat transfer from the combustion gas to the compressed air within the heat exchanger;
supplying heated compressed air from the heat exchanger to a gas turbine comprising a turbine section; and
allowing the heated compressed air to expand through the turbine section of the gas turbine so as to generate mechanical energy.

15. (canceled)

16. (canceled)

17. The method of claim 14 further comprising driving a compressor section of the gas turbine with the mechanical energy generated by the turbine section so as to produce a compressed air stream.

18. The method of claim 15 wherein at least a portion of the compressed air stream is the compressed air supplied to the heat exchanger.

19. The method of claim 14 further comprising driving an electric generator with the mechanical energy generated by the turbine section so as to generate electric power

20. The method of claim 14 wherein an exhaust stream from the turbine section is used to provide thermal energy.
